(19) United States
(12) Patent Application Publication
(10) Pub. No.: US 2019/0311234 A1
(43) Pub. Date: Oct. 10, 2019

(54) INFORMATION PROCESSING APPARATUS, METHOD, AND STORAGE MEDIUM

(71) Applicant: CANON KABUSHIKI KAISHA, Tokyo (JP)

(72) Inventor: Hitoshi Nagasaka, Kashiwa-shi (JP)

(21) Appl. No.: 16/362,493

(22) Filed: Mar. 22, 2019

(30) Foreign Application Priority Data
Apr. 9, 2018 (JP) 2018-075086

(51) Int. Cl. G06K 15/02; G06K 15/12

(52) U.S. Cl. CPC G06K 15/189; G06K 15/129; G06K 15/1855; G06K 15/1836

(57) ABSTRACT

An information processing apparatus includes a memory device that stores instructions and at least one processor that executes the instructions to determine an image rendering instruction as a conversion target to be converted into a cutout rendering instruction among rendering instructions that have been input, convert the image rendering instruction that has been determined as the conversion target into a cutout rendering instruction, and generate a rendering command based on the rendering instructions that have been input and that include the cutout rendering instruction obtained by the conversion.

### BACKGROUND

### Field of the Disclosure

The present disclosure generally relates to information processing and, more particularly, to an information processing apparatus, an information processing method, a storage medium, and to processing of rendering instructions.

### Description of the Related Art

Printer drivers for Windows include Graphics Device Interface (GDI) printer drivers and eXtensible Markup Language (XML) Paper Specification (XPS) printer drivers (hereinafter referred to as V4 printer drivers). The GDI printer driver interprets the GDI data to generate print data, and the V4 printer driver interprets the XPS data to generate print data.

A conventional application outputs a GDI rendering instruction to a GDI printer driver to perform print processing. In this specification, an application for outputting such a GDI rendering instruction is referred to as a GDI application. On the other hand, a new application supporting the V4 printer driver directly outputs an XPS rendering instruction to a V4 printer driver to perform print processing. In this specification, an application capable of outputting such an XPS rendering instruction is referred to as an XPS application. The XPS rendering instruction is passed to the V4 printer driver.

One of the differences in image rendering between a GDI rendering instruction and an XPS rendering instruction is whether transparent images can be handled. While the GDI rendering instruction cannot handle transparent images, the XPS rendering instruction can handle transparent images. A transparent image is an image in which an Alpha value (Alpha Value) is specified for each pixel (i.e., an image having an Alpha channel). In general, in a case where an Alpha value ranges from 0 to 255, a state with the Alpha value=0 means complete transparency, and a state with the Alpha value=255 means complete opacity.

A printer generates image data for print processing based on print data received from a printer driver, and then performs printing on a paper sheet. The print data includes a command in Page Description Language (PDL), and the PDL command is a control code for defining, for example, a type, a size, a color, a position, for rendering. Many different types of PDLs are available, and each of the PDLs defines different kinds of commands and represents different images to be rendered. Among the PDLs, Printer Command Language (PCL®) is one of the PDLs widely used in the world. However, PCL does not define a command for rendering a transparent image. Accordingly, in a case where a rendering instruction for printing a transparent image is input to a V4 printer driver, the V4 printer driver, which outputs print data in PCL format, needs to generate print data that does not include a transparent image in a PCL command by synthesizing the transparent image and an object behind the transparent image to convert the transparent image to an opaque image.

However, when synthesis processing is performed on a transparent image with an object existing behind the transparent image to convert the transparent image to an opaque image, the rendering of the object is treated as an image rendering. A specific example is illustrated in FIGS. 1A and 1B. FIG. 1A is a conceptual diagram illustrating a front-back relationship between a plurality of objects corresponding to a plurality of rendering instructions included in an XPS rendering instruction input to the V4 printer driver. A rectangular area 101 represents a transparent image object when a rendering instruction for the transparent image is executed. In the transparent image object 101, the area having a shape of a star mark is assumed to be completely opaque (Alpha value=255), and the area other than the star mark is assumed to be completely transparent (Alpha value=0). A character object 102 represents an image formed when a character rendering instruction is executed and the character object 102 exists behind the transparent image object 101. In order to generate a PCL command, the transparent image has to be converted into an opaque image. If the whole of the transparent image object 101 is simply converted into an opaque image, the character object 102 behind the transparent image object 101 is hidden. Thus, when the transparent image object 101 is converted into an opaque image, processing for synthesizing the transparent image object and the character object 102 as a background object is also performed based on the Alpha value of the transparent image object 101. FIG. 1B illustrates an example of the object 111 that is an opaque image obtained as a result of synthesis of an image obtained by rendering the transparent image object 101 and an image obtained by rendering the character object 102 existing behind the transparent image object 101 when the transparent image object 101 illustrated in FIG. 1A is converted into an opaque image. In general, an output using PCL commands is as illustrated in FIG. 1A. A character 113 represents a result of synthesizing an image obtained by rendering the character object 102 and the transparent image object 101, so that the rendering of the character object 102 is converted into an opaque image. The rendering instruction of the character object 102 itself may remain unchanged as a PCL type rendering command of the character object 112. However, the image area of the character object 102 is handled as an image obtained by rendering the opaque image 111 at the time of print processing because the opaque image 111 is rendered over the image area of the character object 112. FIG. 2 illustrates a command example when rendering of an opaque image is output in PCL format. From the left to the right, PCL commands, command-attached information, and command-attached information value are listed. Normally, in image rendering by PCL, “BeginImage”, “ReadImage” and “EndImage” are used as PCL commands

Since the character image 113 is synthesized with the opaque image, commands illustrated in FIG. 2 are not rendering commands for text rendering but for image rendering. As a result, when the printer interprets the PCL commands and performs print processing, the area of the character image 113 is treated as an image rendering area. Thus, processing suitable for text rendering is not performed for the area. The processing suitable for text rendering includes smoothing processing and processing for printing black parts of a figure only with black toner. As described above, when a transparent image is converted into an opaque image by synthesizing the transparent image and another type of rendering object (i.e., character object or graphics object such as line image) overlapping the transparent image to convert the transparent image into an opaque image, the original attribute (i.e., text or graphics attribute) of the original type of rendering object is lost. In other words, the rendering of an object such as a character or a graphic that exists behind the transparent image is processed as rendering having an image attribute when the rendering object is synthesized with an opaque image. Thus, printing is performed without processing suitable for rendering an object with a text attribute or processing suitable for rendering an object with a graphics attribute.

Japanese Patent Application Laid-Open No. 2002-016783 discusses a method in which when a printer overlaps images, the printer determines, for each pixel, which of an attribute of an overlapping image and an attribute of an image behind the overlapping image is used as an attribute of the corresponding pixel of the resultant image based on the transmittance of the overlapping image. However, Japanese Patent Application Laid-Open No. 2002-016783 discusses a technique for synthesizing a transparent image in a printer. In addition, since PCL, which is one of PDLs that cannot handle a transparent image, the technique of Japanese Patent Application Laid-Open No. 2002-016783 cannot be applied as is. Furthermore, even if the synthesizing method of Japanese Patent Application Laid-Open No. 2002-016783 is applied to synthesis of a transparent image and a rendering object behind the image at the printer driver side, PCL cannot transmit an attribute of each pixel of the image obtained by the synthesis to the printer using PCL because PCL does not have means for specifying a rendering attribute for each pixel of an image.

When a printer driver that outputs a PDL command that does not handle a transparent image receives a rendering instruction including a transparent image and converts the received rendering instruction into an opaque image, if the printer driver is configured to generate an opaque image by synthesizing the rendering object existing behind the transparent image, the rendering part by the rendering object behind the transparent image is also handled as having an image attribute. Thus, the rendering part is not handled as having its original attribute.

### SUMMARY

According to one or more aspects of the present disclosure, an information processing apparatus includes a memory device that stores instructions, and at least one processor that executes the instructions to determine an image rendering instruction as a conversion target to be converted into a cutout rendering instruction among rendering instructions that have been input, convert the image rendering instruction that has been determined as the conversion target into a cutout rendering instruction, and generate a rendering command based on the rendering instructions that have been input and that include the cutout rendering instruction obtained by the conversion.

Further features of the present disclosure will become apparent from the following description of exemplary embodiments with reference to the attached drawings.

### BRIEF DESCRIPTION OF THE DRAWINGS

FIG. 1A is a diagram illustrating a transparent image and a background image. FIG. 1B is a diagram illustrating an example of synthesis of a transparent image and a background image to convert the transparent image into an opaque image.

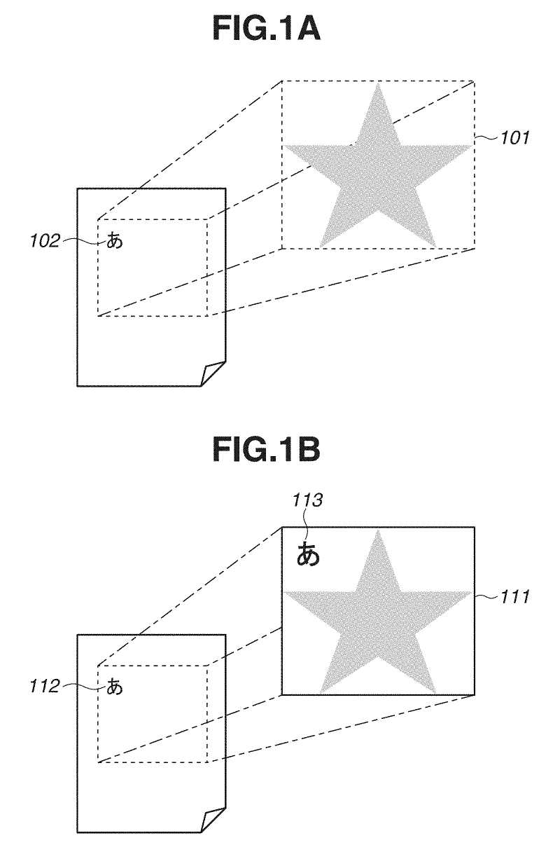

FIG. 2 is a command example illustrating an outline of an image rendering using Printer Command Language (PCL).

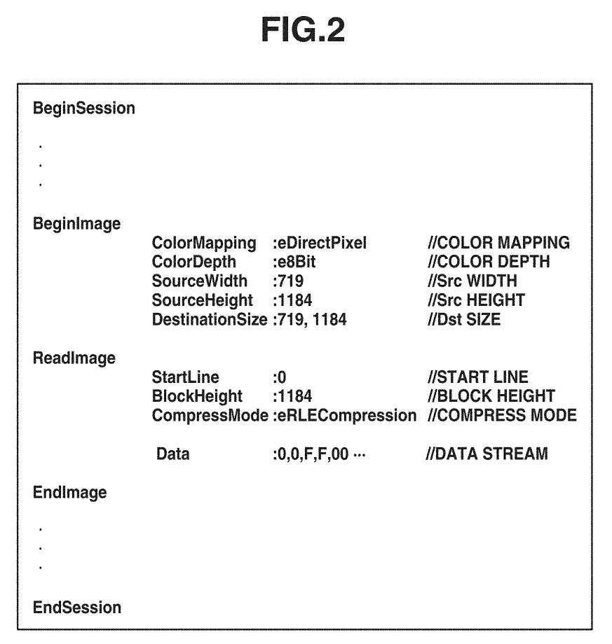

FIG. 3 is a block diagram illustrating an example of an information processing system configuration according to an exemplary embodiment.

FIG. 4 is a system block diagram illustrating a software configuration according to the exemplary embodiment.

FIG. 5 is a flow chart illustrating an entire system according to the exemplary embodiment.

FIG. 6 is a flowchart illustrating optimization processing.

FIG. 7 is a flowchart illustrating detection processing for detecting a conversion target to be converted into a cutout rendering instruction.

FIG. 8 is a flowchart illustrating cutout rendering conversion processing.

FIG. 9A is an example of an image determined to be an image rendering instruction as a conversion target in FIG. 7. FIG. 9B illustrates an example of an image obtained by deleting the Alpha channel from the image illustrated in FIG. 9A. FIG. 9C is a binary image generated based on Alpha values in the image rendering instruction.

FIG. 10 is an outline of a command example of a Raster OPeration (ROP) rendering command using PCL.

FIG. 11 is a diagram illustrating an outline of an example of ROP rendering.

FIG. 12A is a diagram illustrating an example of cutout rendering using a Mask rendering instruction. FIG. 12B is a diagram illustrating an example of cutout rendering using a Clip rendering instruction.

### DESCRIPTION OF THE EMBODIMENTS

Various exemplary embodiments, features, and aspects of the present disclosure will be described in detail below with reference to the drawings.

A first exemplary embodiment of the present disclosure will be described below. First, terms used in description of the present exemplary embodiment are summarized

An “Alpha Value” is a value representing a transparency degree. In the present exemplary embodiment, the value ranges from 0 (i.e., completely transparent) to 255 (i.e., completely opaque). A completely transparent area is an area with Alpha value=0, semi-transparent area is an area with Alpha value=1 to 254, and a completely opaque area is an area with Alpha value=255. An “RGBA image” is a red, green, and blue (RGB) image having an Alpha channel (A) for specifying an Alpha value of each pixel.

The “Raster Operation (ROP) rendering” is a rendering method for determining the value of each pixel for rendering (i.e., destination image) by performing logical operations specified by the ROP code using a source image and a pattern image. The “ROP code” includes a plurality types of code, and each code is assigned to a predetermined operational expression. Details of the ROP code used in the present exemplary embodiment will be described below.

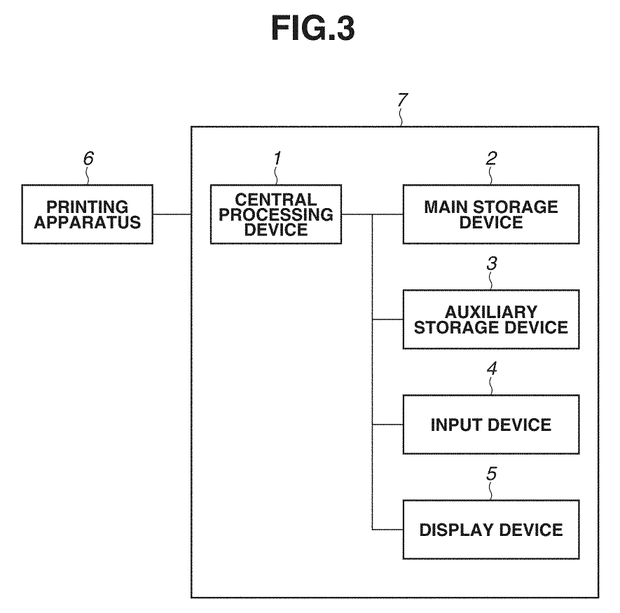

FIG. 3 illustrates a configuration example of an information processing system including an information processing apparatus 7 and a printing apparatus 6 according to the present exemplary embodiment. A central processing device 1, which may include one or more processors, one or more memories, circuitry, or a combination thereof, may load a system program, an application program, or a printer driver from an auxiliary storage device 3 into a main storage device 2 and execute the loaded programs. The auxiliary storage device 3 may be a hard disk drive (HDD), a solid state drive (SSD), a floppy disk (FD), compact disc read only memory (CD-ROM), an integrated circuit (IC) memory card or the like. The central processing device 1 processes information based on an instruction input from an input device 4, and outputs the processing result to a display device 5 and to the printing apparatus 6. In the present exemplary embodiment, the display device 5 is a display unit and displays processing result. The input device 4 may be a keyboard, a pointing device, or the like. The printing apparatus 6 may be connected to the information processing apparatus 7 via a network or the like. A program for realizing the present exemplary embodiment such as a printer driver may be supplied to the information processing apparatus or a system via a network or various computer readable storage media.

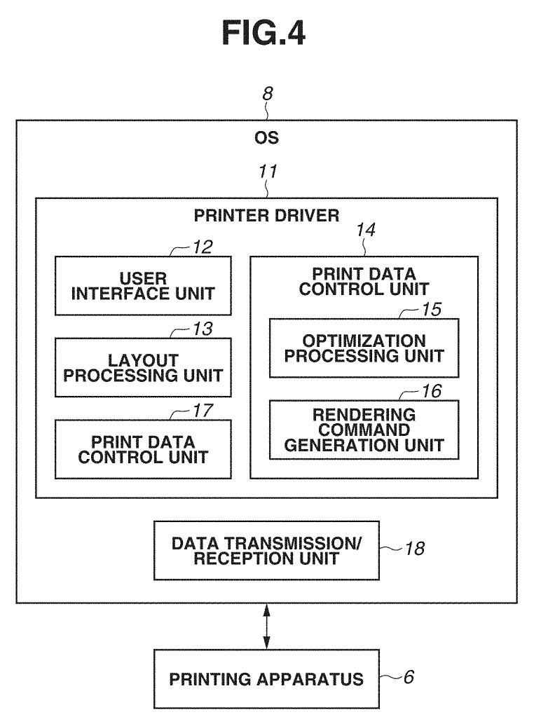

FIG. 4 illustrates an example of software configuration of the present exemplary embodiment. The central processing device (processor) 1 functions as each of processing units 12 to 18 by executing a respective program. The central processing device 1 may control the entire information processing apparatus 7 by executing a program of an operating system (OS) 8.

A printer driver 11 is a program executed on the OS 8 for controlling a printing apparatus, and includes modules for causing the central processing device 1 to function as processing units 12 to 17.

A user interface unit 12 is a unit for a user to input various print settings and to issue a print start instruction.

A layout processing unit 13 receives a rendering instruction issued at the time of printing from an application for creating a document or the like (not illustrated), and performs conversion related to layout such as N-up (N in 1).

A print data control unit 14 receives a rendering instruction that has been subjected to layout conversion processing from the layout processing unit 13, and creates data that can be processed by the printing apparatus 6. The print data control unit 14 performs processing including important processing on the side of the information processing apparatus 7 in a printing system according to the present exemplary embodiment.

When a transparent image is input, an optimization processing unit 15 converts the rendering instruction in such a manner that the rendering object behind the transparent image is appropriately output.

A rendering command generation unit 16 creates a PDL rendering command based on a rendering instruction received from the optimization processing unit 15.

A print data control unit 17 performs, for example, setting of a print job for controlling the entire print data. Then the print data control unit 17 converts the rendering command created by the rendering command generation unit 16 into PDL print data that is supported by the printing apparatus 6 as an output destination. The setting of the print job is to set the print job itself using, for example, Printer Job Language (PJL).

A data transmission/reception unit 18 is one of functions of the OS 8, and transmits/receives data to/from the printing apparatus 6. The data transmission/reception unit 18 transmits the print data generated by the print data control unit 17 to the printing apparatus 6 described below. The printing apparatus 6 performs print processing based on the received print data.

The operation of the printer driver according to the present exemplary embodiment configured as described above will be described with reference to the drawings. A program of the printer driver 11 related to this flow is stored in the auxiliary storage device 3, loaded to the main storage device 2, and executed by the central processing device 1.

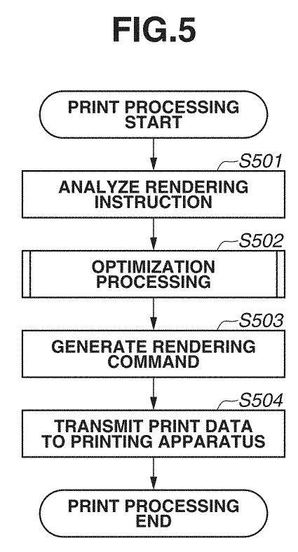

FIG. 5 is a process flow implemented by the central processing device (processor) 1 executing the printer driver 11. When a user performs printing from an application for creating a document or the like, a rendering instruction output from the application is transferred to the printer driver 11. Then the process flow illustrated in FIG. 5 starts.

In step S501, the layout processing unit 13 included in the printer driver 11 analyzes the input rendering instruction and performs layout conversion and the like.

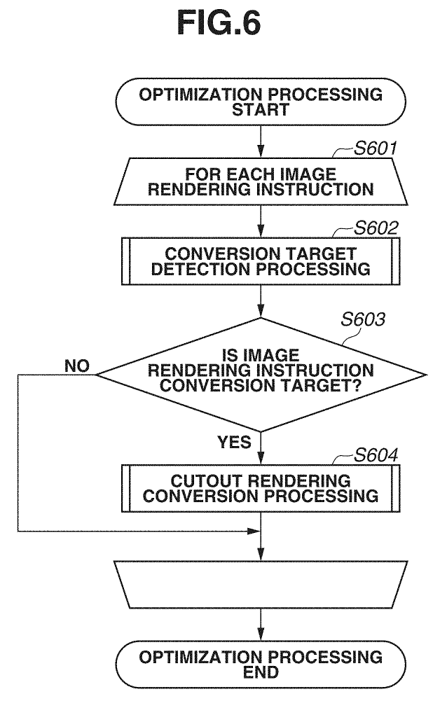

In step S502, the optimization processing unit 15 included in the printer driver 11 performs optimization processing on the rendering instruction received from the layout processing unit 13. Here, as will be described below with reference to FIG. 6, intermediate data is generated by determining a rendering instruction to be converted into a cutout rendering among the rendering instructions having been subjected to layout conversion processing in step S501, and by converting the determined rendering instruction into cutout rendering.

In step S503, the rendering command generation unit 16 included in the printer driver 11 converts the intermediate data (to be described below) obtained as a result of the optimization processing in step S502 into a rendering command that can be processed by the printing apparatus 6. If a rendering instruction including, for example, an Alpha channel remains in the intermediate data, the rendering command generation unit 16 performs, by deleting the Alpha channel or replacing the rendering instruction with another rendering instruction, processing to convert the rendering instruction into a rendering command that can be processed by the printing apparatus. Specifically, the rendering command may be a PDL rendering command such as PostScript (PS) (by Adobe) or PCL (by Hewlett-Packard (HP)). In the present specification, unless otherwise specified, the format of the output PDL is PCL. The intermediate data has a data format in the middle of processing of a rendering instruction in the printer driver 11. The intermediate data may be the same as the rendering instruction after execution of the optimization processing in step S502, or may be a format that is unique to the printer driver to which a rendering instruction after execution of the optimization processing is converted. The present exemplary embodiment is not affected by the format of the intermediate data.

In step S504, the print data control unit 17 of the printer driver 11 generates print data by performing setting of a print job for the PDL rendering command generated in step S503, and transmits the generated print data to the printing apparatus 6 via the data transmission/reception unit 18. The printing apparatus 6 renders the received print data and performs halftone processing thereon, and then prints the print data on paper to complete the print processing.

FIG. 6 is a flowchart illustrating details of the optimization processing described in step S502.

In step S601, the optimization processing unit 15 repeatedly performs the following steps S602, S603, and S604 by sequentially setting, as a processing target, each of the image rendering instructions received from the layout processing unit 13.

In step S602, the optimization processing unit 15 performs “conversion target detection processing” for determining whether the image rendering instruction as the processing target is a “rendering instruction to be converted into cutout rendering instruction”.

If the optimization processing unit 15 determines in step S603 that the image rendering instruction that is set as the processing target in step S601 is a conversion target to be converted into the cutout rendering instruction as a result of the detection processing in step S602 (Yes in step S603), the processing proceeds to step S604. On the other hand, if the optimization processing unit 15 determines in step S603 that the image rendering instruction is not a conversion target to be converted into the cutout rendering instruction (No in step S603), the processing proceeds to step S601. Then, the optimization processing unit 15 determines whether there is any image rendering instruction to be set as a next processing target. If there is such an image rendering instruction, the optimization processing unit 15 performs processing of steps S602 to 5604 on the next processing target. If there is no such image rendering instruction, the processing in FIG. 6 ends and the processing proceeds to step S503.

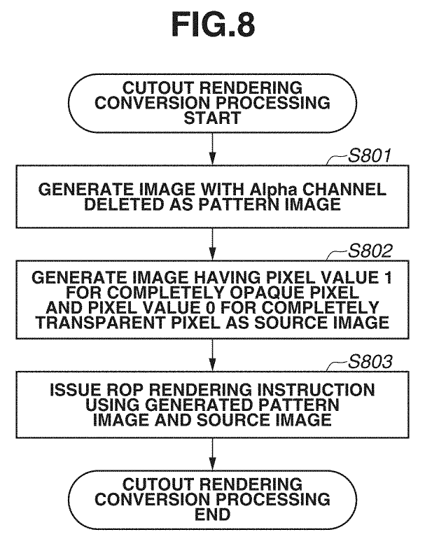

In step S604, the optimization processing unit 15 performs cutout rendering conversion processing on a rendering instruction that has been determined as a conversion target. Details of the cutout rendering conversion processing will be described below with reference to FIG. 8.

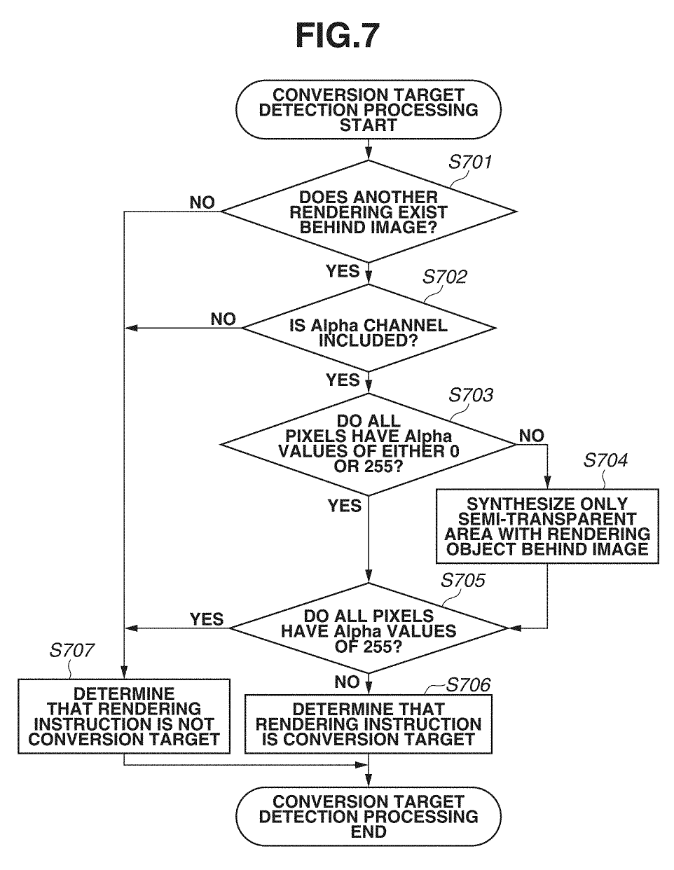

FIG. 7 is a flowchart illustrating details of “conversion target detection processing” for determining whether a rendering instruction is a “rendering instruction to be converted into a cutout rendering instruction” in step S602 of FIG. 6.

In step S701, the optimization processing unit 15 determines whether a rendering object according to another rendering instruction exists behind an image to be rendered according to the image rendering instruction as the processing target. If a rendering object according to another rendering instruction does not exist behind the image (No in step S701), the disadvantageous situation to be improved by the present exemplary embodiment does not occur and thus, the processing proceeds to step S707. On the other hand, if a rendering object according to another rendering instruction exists behind the image (Yes in step S701), the processing proceeds to step S702.

In step S702, the optimization processing unit 15 determines whether the image rendering instruction as the processing target is for an image including an Alpha channel If the image rendering instruction does not include an Alpha channel (No in step S702), the processing proceeds to step S707. If the image rendering instruction includes an Alpha channel (Yes in step S702), the processing proceeds to step S703.

In step S703, the optimization processing unit 15 determines whether the image rendering instruction as the processing target is for an image including pixels all having Alpha values of either 0 (completely transparent) or 255 (completely opaque) set to the Alpha channel In other words, the optimization processing unit 15 determines whether the image rendering instruction is for an image that does not include a semi-transparent pixel (pixel having an Alpha channel value of 1 to 254). If the optimization processing unit 15 determines that the image rendering instruction is for an image that does not include a pixel having an Alpha channel value of 1 to 254 (Yes in step S703), the processing proceeds to step S705. On the other hand, if the optimization processing unit 15 determines that the image rendering instruction is for an image that includes a pixel having an Alpha channel value of 1 to 254 (in other words, if the optimization processing unit 15 determines that the image rendering instruction is for an image including a semi-transparent pixel) (No in step S703), the processing proceeds to step S704.

In step S704, the optimization processing unit 15 performs synthesis processing with another rendering object behind the image only on the semi-transparent area (i.e., the area including a pixel having an Alpha value of 1 to 254) in the image rendering instruction as the processing target to make the Alpha values of the pixels in the area 255 (i.e., completely opaque). The optimization processing unit 15 does not perform synthesis processing with another rendering object behind the image on the completely transparent area (area including pixels having Alpha values of 0) or on the completely opaque area (area including pixels having Alpha values of 255).

In step S705, the optimization processing unit 15 determines whether the image as the processing target includes image pixels all having Alpha values of 255 (completely opaque). In a case where the processing has proceeded through step S704, an image obtained by the synthesis is a target to be determined in step S705. If the optimization processing unit 15 determines that the image includes pixels all having Alpha values of 255 (Yes in step S705), the processing proceeds to step S707. If the optimization processing unit 15 determines that the image includes a pixel having an Alpha value of 0 (No in step S705), the processing proceeds to step S706. If the image includes pixels all having Alpha values of 0 (completely transparent), the image rendering itself may be omitted.

In step S706, the optimization processing unit 15 determines that the image rendering instruction as the processing target is a “conversion target”.

In step S707, the optimization processing unit 15 determines that the image rendering instruction as the processing target is not a “conversion target”.

The conversion target detection processing can be achieved even if the determination of steps S701, S702, S703, and S705 are performed in a different order.

If the optimization processing unit 15 determines in step S701 that another rendering instruction of an object behind the image rendering instruction as the processing target is only a rendering instruction for an image, the processing may proceed to step S702. This is because if another rendering instruction behind the image is originally a rendering instruction for an image, the attribute remains the same as the image attribute even when the rendering instruction is synthesized with the image rendering instruction as the processing target, which does not cause the disadvantageous situation.

As described above, the rendering instruction as a conversion target to be converted into cutout rendering can be detected from other rendering instructions according to the flowchart for the conversion target detection processing illustrated in FIG. 7.

As illustrated in FIG. 7, even if the rendering instruction is for an image having an Alpha channel, a rendering instruction behind which another rendering object does not exist or a rendering instruction of an image with only pixels having Alpha values of 255 are not handled as a conversion target to be converted into cutout rendering instruction. This eliminates the need to convert all the rendering instructions for images each having the Alpha channel to cutout rendering instructions, thereby reducing the load of the conversion processing for cutout rendering instructions.

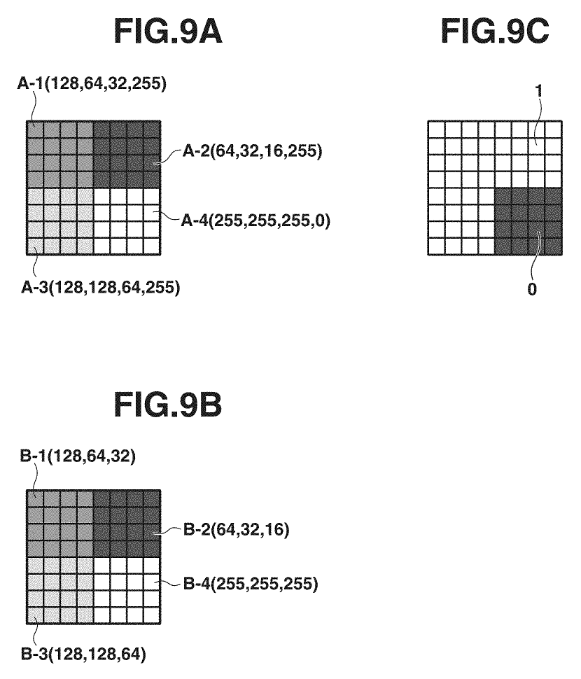

FIG. 8 is a flowchart illustrating details of the cutout rendering conversion processing described in step S604 of FIG. 6. The cutout rendering conversion processing is described referring to specific image examples in FIGS. 9A, 9B and 9C. FIG. 9A is an example of an image determined in FIG. 7 to be an image rendering instruction as a conversion target. The image of FIG. 9A is divided into four areas (i.e., A-1 to A-4) and each area has different pixel values from each other. The values of (R, G, B, A) in each area are indicated.

The cutout rendering instruction is a rendering instruction that instructs cutting out of an area desired to be a rendering target (i.e., cutout target area) and rendering of the area only from a rectangular image so that rendering is not performed on other area (i.e., area other than the cutout target area). In the area other than the cutout target area, rendering is not performed by the rendering instruction. Thus, the pixel values set by previously performed rendering remain as they are.

In the present exemplary embodiment, a cutout rendering instruction using Raster OPeration (ROP) rendering will be described as a cutout rendering instruction. In the present exemplary embodiment, when an image rendering instruction as a conversion target is converted into a “cutout rendering instruction by ROP rendering”, “E2” is used as an ROP code. However, the ROP code is not limited to “E2”.

In step S801, the optimization processing unit 15 generates a pattern image in which the Alpha channel is deleted based on an image according to the image rendering instruction as a conversion target. FIG. 9B illustrates an example of an image obtained by deleting the Alpha channel from the image of FIG. 9A.

In step S802, the optimization processing unit 15 generates, as a source image, a binary image having a pixel value of 1 for each completely opaque pixel (i.e., pixel having an Alpha value of 255) and a binary image having a pixel value of 0 for each completely transparent pixel (i.e., pixel having an Alpha value of 0) based on the Alpha values of the Alpha channel in the image rendering instruction as a conversion target. FIG. 9C is an image example obtained from the image of FIG. 9A in step S802.

In step S803, the optimization processing unit 15 issues an ROP rendering instruction using the pattern image and the source image generated in steps S801 and S802. Specifically, the optimization processing unit 15 issues an ROP rendering instruction having “E2” as the ROP code, the image generated in step S801 as the pattern image, and the image generated in step S802 as the source image. The image rendering instruction as the conversion target is replaced with the issued ROP rendering instruction.

When rendering is performed using the issued ROP rendering instruction, out of the image after the Alpha channel deletion (FIG. 9B), an area corresponding to the pixel value of 1 in the binary image illustrated in FIG. 9C (i.e., B-1, B-2, and B-3) is handled as the cutout target area and rendering is performed, and the other area (i.e., B-4) is not handled as a rendering target. In other words, the image rendering instruction (for example, FIG. 9A) as a conversion target is converted into an image rendering instruction (FIG. 9B) that does not include an Alpha channel, and is converted into an ROP rendering instruction that defines an area (i.e., A-1, A-2, and A-3), which includes pixels that are completely opaque in the image rendering instruction as the conversion target, as a cutout target (rendering target).

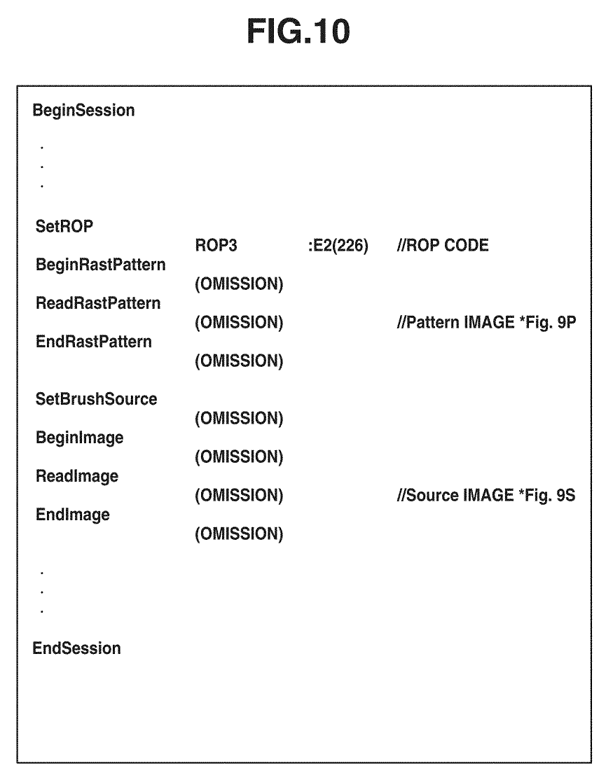

FIG. 10 illustrates an example of a PCL command obtained by the conversion into the cutout rendering instruction using the ROP rendering by means of the processing described with reference to FIG. 8. First, “SetROP” is used to set “E2” to the ROP code.

Next, the pattern image is set using “BeginRastPattern”, “ReadRastPattern” and “EndRastPattern”. Then the source image is set using “SetBrushSource”, “BeginImage”, “ReadImage” and “EndImage” to complete the command sequence using ROP rendering of the PCL command

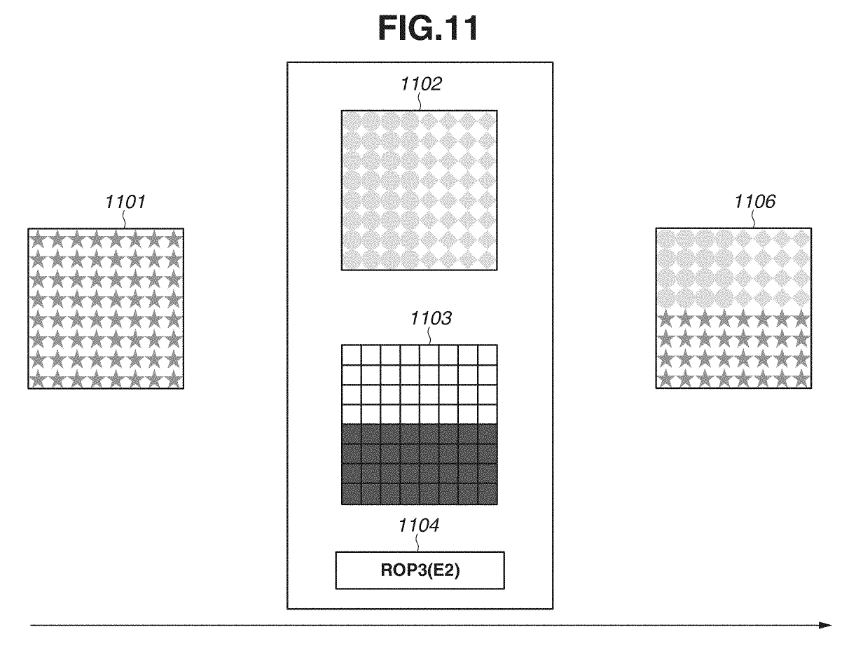

FIG. 11 is a diagram illustrating an outline of a cutout rendering instruction when using the ROP code “E2”. An image 1101 is an example of an image, in a rendering area, (referred to as a Destination image) rendered by a previous rendering instruction (i.e., the rendering instruction of a rendering object behind the image as a conversion target). The cutout rendering instruction using ROP rendering includes a Pattern image 1102, a Source image 1103, and an ROP code 1104. A result of execution of this cutout rendering instruction on the Destination image 1101 is an image 1106. The ROP code “E2” indicates a logical operation for rendering an image having pixel values of the Pattern image in an area where the pixel value is 1 (i.e., white) in the Source image and for leaving the pixel values of the Destination image in an area where the pixel value is 0 (i.e., black) in the Source image.

As described above, the ROP code is not limited to “E2” and, for example, “B8” can be used as the ROP code. In a case where the ROP code “B8” is used, the same cutout rendering result as in the case where the ROP code “E2” is used can be obtained by inverting the pixel values 1 and 0 in the binary image generated as a source image in step S802.

It is also possible to issue a cutout rendering instruction using an ROP code other than “E2” or “B8”. Depending on the type of an ROP code, the image obtained by deleting the Alpha channel generated in step S801 may be used as a source image, and the binary image generated in step S802 may be used as a pattern image. For example, in a case where ROP code “CA” is used, a cutout rendering instruction may be issued by using the image obtained by deleting the Alpha channel generated in step S801 as the source image and by using the binary image generated in step S802 as the pattern image. In a case where ROP code “AC” is used, a cutout rendering instruction may be issued by using the image obtained by deleting the Alpha channel generated in step S801 as the source image and using the binary image obtained by inverting the pixel values 1 and 0 in the binary image generated in step S802 as the pattern image.

Even in a case where any ROP code is used, an operation is performed such that an image in which the Alpha channel is deleted from the image as a conversion target is generated, an area corresponding to pixels that are completely opaque in the image as the conversion target is defined as the cutout target area (rendering target area). For the cutout target area, the cutout target area in the image after deletion of the Alpha channel generated as described above is rendered in a rendering destination memory (i.e., memory in which an image that has been rendered according to the rendering instruction for a rendering object behind the conversion target is stored). An area other than the area is handled as an area that is not a rendering target and the pixel values in the area are left as they are.

As described above, among the rendering instructions input to the printer driver, a rendering instruction as a conversion target to be converted into cutout rendering is detected, and the rendering instruction as a conversion target is converted into a cutout rendering. Thus, when a transparent image is converted into an opaque image, characters, graphics and the like existing behind the transparent image are not synthesized with the opaque image as much as possible. Therefore, portions corresponding to rendering objects such as a character and graphics can be processed with original rendering attributes.

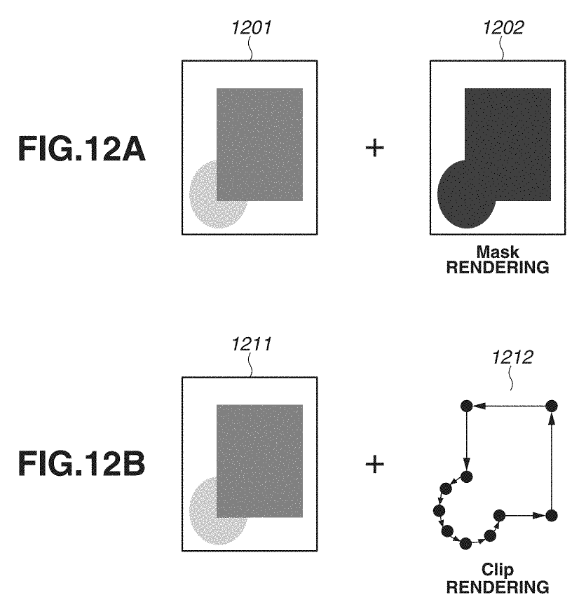

A second exemplary embodiment of the present disclosure will be described below. In the first exemplary embodiment, the ROP rendering is used as the cutout rendering instruction. However, the cutout rendering instruction is not limited to the ROP rendering, a cutout rendering instruction other than the ROP rendering can be used depending on the features in an image as a conversion target. FIGS. 12A and 12B are diagrams illustrating examples of other cutout rendering instructions.

For example, if PDL compatible with a Mask rendering instruction is used, a Mask rendering instruction can be used as a cutout rendering instruction as illustrated in FIG. 12A. In this rendering, in the image 1201 after deletion of the Alpha channel, pixels to be rendered are represented in an image 1202 (referred to as a Mask image). The Mask image 1202 can be created by setting the pixel values corresponding to pixels having completely opaque Alpha channel to 1 and by setting the pixel values corresponding to pixels having completely transparent Alpha channel to 0 similarly to the method for creating the cutoff area illustrated in FIG. 9C.

FIG. 12B illustrates an example in which the Clip rendering instruction is used as a cutout rendering instruction. In this rendering, in the image 1211 after deletion of the Alpha channel, pixels to be rendered are represented by vector information 1212. The vector information 1212 can be created by extracting a boundary between pixels having completely opaque Alpha channel and pixels having completely transparent Alpha channel, or by creating a binary image illustrated as the Mask image 1202 and extracting an edge in the binary image.

As described above, according to the second exemplary embodiment, the Mask rendering instruction or the Clip rendering instruction can be used as the cutout rendering instruction as a type of PDL.

According to the first or second exemplary embodiment described above, when a rendering instruction for a transparent image is converted into an opaque image, the influence on other rendering objects can be suppressed.

The units described throughout the present disclosure are exemplary and/or preferable modules for implementing processes described in the present disclosure. The term “unit”, as used herein, may generally refer to firmware, software, hardware, or other component, such as circuitry or the like, or any combination thereof, that is used to effectuate a purpose. The modules can be hardware units (such as circuitry, firmware, a field programmable gate array, a digital signal processor, an application specific integrated circuit, or the like) and/or software modules (such as a computer readable program or the like). The modules for implementing the various steps are not described exhaustively above. However, where there is a step of performing a certain process, there may be a corresponding functional module or unit (implemented by hardware and/or software) for implementing the same process. Technical solutions by all combinations of steps described and units corresponding to these steps are included in the present disclosure.

### Other Embodiments

Embodiment(s) of the present disclosure can also be realized by a computerized configuration(s) of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computerized configuration(s) of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computerized configuration(s) may comprise one or more processors, one or more memories, circuitry, or a combination thereof (e.g., central processing unit (CPU), micro processing unit (MPU), or the like), and may include a network of separate computers or separate processors to read out and execute the computer executable instructions. The computer executable instructions may be provided to the computerized configuration(s), for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2018-075086, filed Apr. 9, 2018, which is hereby incorporated by reference herein in its entirety.

What is claimed is:

1. An information processing apparatus comprising:
a memory device that stores instructions; and
at least one processor that executes the instructions to:
determine an image rendering instruction as a conversion target to be converted into a cutout rendering instruction among rendering instructions that have been input;
convert the image rendering instruction that has been determined as the conversion target into a cutout rendering instruction; and
generate a rendering command based on the rendering instructions that have been input and that include the cutout rendering instruction obtained by the conversion.

2. The information processing apparatus according to claim 1, wherein the at least one processor executes the instructions to determine, as the conversion target, a rendering instruction for an image that has an Alpha channel, that is front of a rendering object of another rendering instruction, and that is determined to include a completely transparent pixel and a completely opaque pixel based on Alpha values of the Alpha channel among the rendering instructions that have been input.

3. The information processing apparatus according to claim 1, wherein the at least one processor executes the instructions to determine, as the conversion target, a rendering instruction for an image that has an Alpha channel, and that is front of a rendering object of another rendering instruction among the rendering instructions that have been input.

4. The information processing apparatus according to claim 1, wherein the at least one processor executes the instructions to determine, as the conversion target, a rendering instruction for an image that has an Alpha channel, and that is determined to include a completely transparent pixel and a completely opaque pixel based on Alpha values of the Alpha channel among the rendering instructions that have been input.

5. The information processing apparatus according to claim 4, wherein the at least one processor executes the instructions to, in a case where a rendering instruction among the rendering instructions that have been input is determined as a rendering instruction for an image including a semi-transparent pixel based on an Alpha value of the Alpha channel, convert the semi-transparent pixel into a completely opaque pixel by synthesizing the semi-transparent pixel and a rendering object of another rendering instruction existing behind the image rendered by the rendering instruction, and determine a rendering instruction for the image obtained by the conversion as the conversion target in a case where the image obtained by the conversion includes a completely transparent pixel and a completely opaque pixel.

6. The information processing apparatus according to claim 4, wherein a pixel having 0 as an Alpha value of the Alpha channel is a completely transparent pixel, a pixel having 255 as an Alpha value of the Alpha channel is a completely opaque pixel, and a pixel having 1 to 254 as an Alpha value of the Alpha channel is a semi-transparent pixel.

7. The information processing apparatus according to claim 4, wherein the at least one processor executes instructions to convert the image rendering instruction that is the conversion target into the cutout rendering instruction in which an area including a completely opaque pixel indicated by an Alpha value of the Alpha channel is defined as an area that is a rendering target, and an area including a completely transparent pixel indicated by an Alpha value of the Alpha channel is defined as an area that is not a rendering target.

8. The information processing apparatus according to claim 7, wherein the at least one processor executes the instructions to use a Raster OPeration (ROP) rendering instruction as the cutout rendering instruction.

9. The information processing apparatus according to claim 8, wherein the at least one processor executes the instructions, based on the image rendering instruction that has been determined as the conversion target, to generate an image in which the Alpha channel is deleted, generate a binary image based on the completely opaque pixel and the completely transparent pixel indicated by an Alpha value of the Alpha channel, generate a cutout rendering instruction using the image in which the Alpha channel is deleted, the binary image, and the ROP code, and replace the image rendering instruction that is the conversion target with the cutout rendering instruction that has been generated.

10. The information processing apparatus according to claim 7, wherein the at least one processor executes the instructions to use a Mask rendering instruction as the cutout rendering instruction.

11. The information processing apparatus according to claim 7, wherein the at least one processor executes instructions to use a Clip rendering instruction as the cutout rendering instruction.

12. An information processing method comprising:
determining an image rendering instruction as a conversion target to be converted into a cutout rendering instruction among rendering instructions that have been input;
converting the image rendering instruction that has been determined as the conversion target into a cutout rendering instruction; and
generating a rendering command based on the rendering instructions that have been input and that include the cutout rendering instruction obtained by the conversion.

13. A non-transitory computer readable storage medium storing a program for causing a computer to execute a control method executed in an information processing apparatus, the control method comprising:
determining an image rendering instruction as a conversion target to be converted into a cutout rendering instruction among rendering instructions that have been input;
converting the image rendering instruction that has been determined as the conversion target into a cutout rendering instruction; and
generating a rendering command based on the rendering instructions that have been input and that include the cutout rendering instruction obtained by the conversion.
